(19) United States
(12) Patent Application Publication
(10) Pub. No.: US 2026/0253825 A1
(43) Pub. Date: Aug. 27, 2026

(54) SWITCHING DEVICE

(71) Applicant: Ellenberger & Poensgen GmbH, Altdorf (DE)

(72) Inventors: Markus BIRNER, Zirndorf (DE); Manuel ENGEWALD, Nuernberg (DE); Stefan HOLBE, Nuernberg (DE); Julian KAISER, Erlangen (DE); Hendrik-Christian KOEPF, Nuernberg (DE)

(73) Assignee: Ellenberger & Poensgen GmbH, Altdorf (DE)

(21) Appl. No.: 19/461,175

(22) Filed: Jan. 27, 2026

(30) Foreign Application Priority Data
Jan. 27, 2025 (DE) 10 2025 102 797.8

(51) Int. Cl. H01H 50/18; H01H 47/04

(52) U.S. Cl. CPC H01H 50/18; H01H 47/04

(57) ABSTRACT

A switching unit having a mechanical switch which is driven by an electric actuator which has an armature mounted so as to be movable along an adjustment path between a first stop and a second stop. The electric actuator is designed such that a magnetic first holding force is formed between the first stop and the armature and a magnetic second holding force is formed between the second stop and the armature, wherein the first holding force differs from the second holding force.

### CROSS-REFERENCE TO RELATED APPLICATIONS

This nonprovisional application claims priority under 35 U.S.C. § 119(a) to German Patent Application No. 10 2025 102 797.8, which was filed in Germany on January 27, 2025, and which is herein incorporated by reference.

### BACKGROUND OF THE INVENTION

### Field of the Invention

The invention relates to a switching unit having a mechanical switch which is driven by means of an electric actuator.

### Description of the Background Art

Circuit breakers are usually used to protect an electrical line or a device against a malfunction of the associated circuit, for example, an excessive applied electric voltage or an excessive flowing electric current. This occurs, for example, if the device to be protected or the electric line is already damaged. In this case, the circuit breaker interrupts the current flow, so that further damage is prevented.

To interrupt the current flow, the circuit breaker has a switching unit with a switch. The switch is arranged inside a housing to provide protection against contact and for easy installation. The switch is designed as a semiconductor switch, for example. Due to its design, the switch has an internal resistance, which is why it heats up during operation, at least when a relatively large electric current is being conducted. Cooling is therefore required. Efficiency is also reduced.

In an alternative to this, the switch is of mechanical design, which is why electrical resistance is reduced. The mechanical switch usually has a movable contact which can be moved relative to a fixed contact. If these are spaced apart from each other, the mechanical switch is open. When the movable contact is in contact with the fixed contact, the mechanical switch is closed, so that an electric current can flow via the mechanical switch.

The movable contact is usually acted upon at least indirectly by a spring, wherein the acting spring force is such that the movable contact is spaced apart from the fixed contact. To enable the desired current conduction by means of the mechanical switch, a latching mechanism is usually present, which is only released when a certain condition is met, so that the movable contact is spaced apart from the fixed contact. In this case, the latching mechanism is designed, for example, as a bimetallic element via which the electric current conducted by the switching unit is conducted. In the event of an excessive electric current, the bimetallic element heats up and therefore deforms, which is why the latch is released and the mechanical switch is opened.

In a refinement, in addition, there is an electric actuator which also acts on the movable contact. This is usually designed in such a way that the mechanical switch is set to the electrically conductive state when the actuator is energized. The opening, for example, is only carried out by means of the spring. In this regard, for example, the mechanical switch is only held in the closed state as long as the actuator is energized, which increases safety. So that a high switching speed is realized here, it is necessary to exert a high force by means of the spring, which leads to an increased size, complicated assembly, and a large housing.

In a refinement, the actuator is also energized in the opposite direction for opening, so that the movable contact is also spaced apart from the fixed contact by means of the actuator. In this case, however, the actuator must first be remagnetized, which is why the force acting on the movable contact only increases gradually. As a result, the mechanical switch opens relatively slowly at first. In order to increase the switching speed, a relatively powerful actuator is required, which is why the size and manufacturing costs are increased.

### SUMMARY OF THE INVENTION

It is therefore an object of the present invention to provide a suitable switching unit, wherein advantageously a switching speed is increased and/or manufacturing costs are reduced.

The switching unit can be used in particular for switching an electric current, therefore, in particular for creating and/or interrupting an electric current flow. For this purpose, the switching unit expediently has two states, namely, an electrically conductive state, which is also referred to as the closed state. In this case, it is possible to conduct the electrical current by means of the switching unit. In the other state, which is referred to as the open or electrically nonconductive state, in particular, an electric current flow through the switching unit is not possible. For example, the switching unit is manually operated/operable, so that the switching unit is a manual switch. Alternatively or in combination with this, it is possible, for example, to actuate the switching unit electrically and thus, in particular, remotely. In a further alternative, the switching unit is actuated automatically, for example, expediently depending on certain conditions. The switching unit is suitably a component of a circuit breaker or a contactor.

The circuit breaker can be used to protect a device, for example, and the circuit breaker is device circuit breaker, for example. Alternatively or in combination with this, the circuit breaker is used to protect a line and is therefore a line circuit breaker. In particular, the circuit breaker is used in a direct current voltage circuit, thus, for example, between a load and a direct current voltage source or the like, so that a circuit is formed in particular. Preferably, a DC voltage between 400 V and 650 V is present in the DC voltage circuit, therefore, a higher DC voltage in particular. The circuit breaker is preferably used to protect an actuator in an industrial plant. The actuator here forms the load in particular. The circuit breaker or at least the switching unit is expediently used in the field of industrial automation. In particular, the electric voltage switched by the circuit breaker/switching unit is 24 V, 48 V, 380 V, 650 V, and 760 V. In one alternative, the circuit breaker is used for protection or at least the switching unit is used for switching street lighting, an on-board ship network, rail infrastructure applications, railway propulsion applications, or in the field of electrified aviation. In a further alternative, the circuit breaker/switching unit is used in the expansion and integration of renewable energy generators, in island grids, in the private residential sector, in greenhouses, in the electrification of road-based mobility (electromobility), agriculture, or construction site vehicles. The electric (direct) voltage used is, for example, between 1500 V and 3000 V or is 110 V, 380 V, 400 V, 800 V, 1000 V, 1500 V, or 3000 V. In summary, as an alternative to the application in an industrial plant, the circuit breaker/switching unit is used, for example, in an electric vehicle, such as a motor vehicle, an aircraft, or a ship/boat.

The switching unit can be designed as a disconnector or a component thereof, which is also referred to as an isolator. For example, the switching unit comprises a mechanical lever by means of which the switching state of the switching unit can be changed.

The switching unit expediently can comprise two device terminals to which additional components of the circuit are connected in the installed state. The device terminals are suitable, in particular provided and configured for this purpose. Expediently, a cable or busbar is connected to the respective device terminal for this purpose, wherein a cross section of this is, for example, between 10 mm2 and 100 mm2 or between 25 mm2 and 92 mm2. The cross section is 16 mm2, 25 mm2 or 35 mm2, for example. The cross section is, for example, 6 mm2, between 6 mm2 and 16 mm2, or between 16 mm2 and 50 mm2. In particular, the device terminals are designed in the form of cage clamps or at least comprise them. The two device terminals are expediently electrically connected to each other by means of a current path. For example, the two device terminals are electrically connected directly to each other via the current path, or yet another component is electrically connected in series to the current path, via which component and the current path the two device terminals are then electrically connected to each other.

The switching unit suitably can have a housing which can be made of plastic. In particular, all other components of the switching unit are arranged in the housing. Expediently, the housing forms an outer boundary of the switching unit. This provides protection against accidental contact and the components are protected from environmental influences. For example, the housing is designed in one piece, which increases tightness. Alternatively, the housing is made up of a number of housing parts. The housing is particularly preferably formed by two shells placed on top of each other. Assembly is thus facilitated. Any current path is suitably arranged in the housing. Expediently, any device terminals are conveniently incorporated into the housing, so that electrical contacting with the current path can be made from outside the housing.

The switching unit can have a mechanical switch, which is suitably arranged in the possibly present housing. Expediently, the mechanical switch forms part of any current path. The mechanical switch is therefore electrically connected between the two device terminals of the switching unit. Consequently, it is possible to switch an electric current flow via the current path using the mechanical switch. For example, the current path has additional components or, for example, the current path is only formed by the mechanical switch and any electrical cables, such as busbars, that lead to the mechanical switch. Thus, manufacturing costs are reduced.

The mechanical switch can have a movable contact which is, in particular, mounted so as to be movable along an additional adjustment path. Expediently, the mechanical switch comprises a contact bridge which has the movable contact. For example, the contact bridge comprises a bridge body to which the movable contact is attached. For example, the movable contact is made in one piece with the bridge body, or expediently the movable contact and the bridge body are made of different materials. In particular, the bridge body is made of copper. For example, the movable contact is firmly soldered, welded, or riveted to the bridge body. In particular, the contact bridge, or more suitably the optional bridge body, is strip-like and thus has a main direction of expansion. Preferably, in this case, the movable contact is assigned to one of the ends of the contact bridge in the main direction of expansion.

Expediently, the mechanical switch can have a fixed contact. Preferably, the fixed contact here is a component of a terminal. The terminal suitably has a terminal body which is made of copper, for example. For example, the fixed contact is made of the same material as the terminal body and, in particular, is molded onto it. Expediently, however, these are made from different materials, in particular from a metal. For example, the fixed contact is firmly soldered, welded, or riveted to the terminal body. The terminal or at least the fixed contact is expediently held rigidly on the optional housing, so that relative movement of the fixed contact with respect to the housing is not possible.

The contact bridge can be mounted so as to be movable relative to the fixed contact along the additional adjustment path, thus, in particular, also relative the optional housing. It is thus possible to move the contact bridge, and therefore also the movable contact, relative to the fixed contact. The mechanical switch is preferably designed here such that the movable contact is in contact with the fixed contact in a/the closed state of the mechanical switch, whereby a direct mechanical contact between these is expediently realized. In an/the open state, in contrast, the movable contact is spaced apart from the fixed contact. To change the state of the mechanical switch, the contact bridge is therefore moved along the additional adjustment path, whereby the distance between the movable contact and the fixed contact is changed.

In particular, the movement of the contact bridge in one direction can be limited hereby by the movable contact being in contact with the fixed contact. When the contact bridge is moved in the opposite direction, in contrast, the two contacts are spaced apart, so that an air gap in particular is formed between them. In this state, the mechanical switch is preferably electrically nonconductive and/or open. Consequently, it is possible to change a switching state of the mechanical switch by moving the contact bridge or at least the movable contact.

For example, the further adjustment path can be curved. However, the additional adjustment path is particularly preferably straight. The additional adjustment path is in particular perpendicular to the extension of the contact bridge. Thus, construction is simplified. For example, the mechanical switch only comprises a single movable contact. Particularly preferably, however, the mechanical switch has an additional movable contact, which is preferably also a component of the optional contact bridge. The additional movable contact is assigned an additional fixed contact, which is in particular a component of an additional terminal. Expediently, the two movable contacts, the two fixed contacts, and/or the two terminals are structurally identical to each other. In this case, the mechanical switch is expediently designed in such a way that the two movable contacts are in contact with the respective fixed contact when the mechanical switch is in the closed state, therefore, in the electrically conductive state. By moving the contact bridge of the additional adjustment path, each movable contact is then spaced apart from the respective assigned fixed contact. Consequently, the mechanical switch is suitably designed as a double-break switch, which is why the electrical voltage applied between each fixed contact and the associated movable contact is reduced when the mechanical switch is in the open (switching) state. As a result, an arc is prevented from forming there, or this only occurs when a relatively high electrical voltage is applied.

Expediently, an extinguishing chamber can be assigned to the fixed contact and the movable contact. The extinguishing chamber is used in particular to extinguish an arc formed between them when the mechanical switch is opened. For this purpose, the extinguishing chamber expediently comprises a plurality of splitter plates or the like. These are made of metal and/or ceramic. If the two movable contacts and the two fixed contacts are present, two corresponding extinguishing chambers are expediently present.

Preferably, the extinguishing chamber can also comprise a blow-out device, such as a permanent magnet and/or a steel core. Preferably, the blow-out device comprises one or more blow-out plates, between which the splitter plates are arranged. A magnetic field is provided by the blow-out device, so that the Lorentz force acts on the arc present between the movable contact and the fixed contact, as a result of which the arc is driven between the splitter plates.

The switching unit can comprise an electric actuator, which is also suitably arranged in the optional housing. The mechanical switch is driven by the electric actuator. In this regard, it is suitably possible to change the state of the mechanical switch by means of the electric actuator. The electric actuator has an armature mounted so as to be movable along an adjustment path. The armature is driven in particular. The armature is suitably in operative connection with the optional contact bridge or at least connected to the mechanical switch. Preferably, the adjustment path is parallel to the additional adjustment path assigned to the contact bridge, which facilitates construction.

The electric actuator can have an electrical coil which is suitably held in a fixed position. In other words, the electrical coil is particularly preferably rigidly attached to the optional housing, for example, directly or via additional components. During operation of the electric actuator, the electrical coil is energized. The armature is in particular designed as a permanent magnet or comprises one. Alternatively, the armature expediently comprises a ferromagnetic component. Preferably, the adjustment path lies on an axis of the electrical coil. For example, the armature is circumferentially surrounded by the electrical coil or offset with respect thereto along its axis. Preferably, the electric actuator is designed such that during operation of the actuator, therefore, in particular when the electrical coil is energized, the armature is moved along the axis of the electrical coil, that is, along the adjustment path.

The electric actuator can have a first stop and a second stop, between which the adjustment path extends. The armature is thus mounted so as to be movable between the two stops. For example, it is possible to move the armature up to the respective stop, so that the movement of the armature is stopped by it, where, for example, the armature strikes directly against the stop. Alternatively, the stop is, for example, slightly offset relative to an end position of the adjustment path, which reduces mechanical stress. Thus, at least one of the adjustment path ends is slightly offset from the associated stop.

The electric actuator can be such that a first magnetic holding force is formed between the first stop and the armature. The first holding force acts in particular on the armature in the direction of the first stop. The first holding force therefore arises in particular when the armature is in contact with the first stop or has at least reached the adjustment path end associated with the first stop. In this regard, the first holding force corresponds to the force that forms/prevails between the armature and the first stop when the armature is in contact with the first stop or has at least reached the adjustment path end associated with the first stop. In this case, the first holding force arises due to magnetic fields acting in particular between the armature and the first stop. The armature is held against the first stop by means of the first holding force, and the armature only moves away from the first stop when the first holding force has been overcome. Expediently, the first holding force is independent of the energization of the electric actuator and therefore acts in particular intrinsically and/or statically. If the armature is spaced apart from the first stop, the magnetic fields in particular continue to exist, wherein, however, the force acting on the armature in the direction of the first stop is reduced due to the distance, for example. Thus, the first holding force in particular represents the maximum of the magnetic force which acts between the first stop and the armature and is realized in particular when the distance between the armature and the first stop is minimal.

Further, the electric actuator can be designed such that a second magnetic holding force is formed between the second stop and the armature. This force is caused in particular by magnetic fields and is expediently based on the same principle as the first holding force, wherein, however, it is associated with the second stop. At least the second holding force is expediently directed from the armature in the direction of the second stop and occurs in particular when the armature is in contact with the second stop or has at least reached the adjustment path end associated with the second stop. When the armature is spaced apart from the second stop, the magnetic fields and the force generated thereby still prevail, wherein, however, the magnitude of the force is reduced due to the distance. Thus, the second holding force in particular represents the maximum force acting between the armature and the second stop, at least in particular when the electric actuator is not energized.

In summary, the first holding force and the second holding force can be provided by means of static magnetic fields, wherein, for example, the same magnetic fields or different magnetic fields always act in this case. In particular, the same magnetic fields always act on the armature, wherein the magnitude of the forces generated thereby depends on the position of the armature. In particular, the respective holding force is a holding force by means of which the armature is held in the respective position at the adjustment path end associated with to the respective stop. For example, in addition, other forces are also present.

The first holding force can differ from the second holding force. In other words, the first and second holding forces in particular differ in terms of magnitude. Consequently, to take the armature away from the adjustment path end associated with the first stop, a different force is required than is required to take the armature away from the adjustment path end associated with the second stop. Thus, to move the armature from the first stop to the second stop along the adjustment path, a different force is required than when moving it in the opposite direction.

Because the same electrical coil, by means of which a corresponding magnetic field is provided, is always used to move the armature, the acceleration acting on the armature due to the different holding forces depends on the direction of movement along the adjustment path. This leads to different switching speeds of the mechanical switch. Thus, the switching speed can be increased for critical switching situations of the mechanical switch, that is, for switching on or off, whereas the switching speed is reduced for other switching situations. Safety is thus increased and, in particular, it is not necessary to change a dynamic part of the electric actuator, that is, in particular any electrical coil. Thus, manufacturing costs are reduced wherein an increased switching speed is nevertheless realized at least in part.

In addition, it is possible, for example, to select the current supply to the electrical coils depending on the switching situation and/or to use different electrical coils for this purpose. Thus, for example, due to the different holding forces, it is possible to use an electrical coil with a relatively small number of electric windings for a switching situation, which reduces manufacturing costs. In another situation, in contrast, relatively many windings are used, so that the increased holding force can be compensated for. Because the force acting between the armature and the associated stop decreases relatively quickly with increasing distance after the holding force has been overcome, but the magnetic force provided by the electrical coil is essentially constant, the acceleration of the armature increases relatively sharply, which is why a relatively fast switching speed is realized.

Preferably, both holding forces are greater than 0 N. For example, one of the two holding forces is relatively low, so that the switching unit is monostable. In this case, the armature is only held on the side of the adjustment path where the increased holding force is present. To hold the armature at the other stop, a current supply to the electric actuator is, for example, always required. If a fault condition is present and no energization can take place, the armature is automatically moved to the other stop. However, it is particularly preferable for the switching unit to be bistable, so that when the armature has in each case reached one of the ends of the adjustment path and no further energization of the electric actuator takes place, the armature remains at the respective end of the adjustment path.

For example, the switching unit may only comprise the mechanical switch. Particularly preferably, however, the switching unit also comprises a semiconductor switch, which is designed, for example, as a field-effect transistor, such as a MOSFET, or as an IGBT, or GTO. The semiconductor switch, for example, is electrically connected in series to the mechanical switch. It is thus possible to first interrupt the electric current using the semiconductor switch and then to open the mechanical switch. Thus, the formation of an electric arc is prevented, and a galvanic isolation still occurs. Alternatively, for example, the semiconductor switch is connected electrically in parallel to the mechanical switch. If the mechanical switch is open but an arc is formed there, it is possible to briefly set the semiconductor switch to the electrically conductive state. As a result, the arc breaks, so that the electric current flow via the mechanical switch is interrupted. The semiconductor switch is then returned to the electrically nonconductive state. In this case, the arc is not re-established, and the electric current is interrupted. Alternatively, the semiconductor switch is set to the electrically conductive state before the mechanical switch is opened. If the mechanical switch is then set to the electrically nonconductive state, that is, opened, the electric current is conducted by the semiconductor switch, which is why no arc is formed in the mechanical switch. After this, the semiconductor switch is also set to the electrically nonconductive state, so that no more electrical current is conducted via the switching unit.

For example, the electric actuator, which in particular is also referred to simply as an actuator, can comprise only the single possibly present electrical coil. Alternatively, the electric actuator comprises a plurality of such electrical coils, so that the force provided by the electric actuator is increased. The electric actuator is designed as a "moving magnet actuator," for example. The armature, which is movably mounted, is also associated with the "moving magnet actuator." In addition, the "moving magnet actuator" has an actuator unit with one or more electrical coils which are energized when the electric actuator is actuated, so that a magnetic interaction takes place between them and the armature. The electrical coils are held stationary in this case. Because the electrical coil(s) is/are held stationary, construction is simplified and, with the exception of the components required for mounting, no other moving components or electrical connections are required between the moving components, namely, the armature, and the stationary components of the "moving magnet actuator." Thus, friction of the "moving magnet actuator," which is also referred to below simply as the actuator, is also reduced.

Preferably, the actuator unit can comprise two electrical coils, which are structurally identical, for example. However, the two electrical coils are at least offset to each other along a longitudinal axis and arranged concentrically to it. The armature is located in particular on the longitudinal axis and is mounted so as to be movable along it. A magnetic short-circuit plate is suitably located in an air gap between the two electrical coils, which improves the magnetic interaction.

Because the number of moving components of the "moving magnet actuator," in particular only the armature, is relatively small, and it in particular has a relatively low weight, the dynamics of the actuator are relatively high. Thus, inertia when the mechanical switch is actuated is reduced. As a result, the switching unit enables relatively rapid switching.

Expediently, the mechanical switch can comprise a contact bridge carrier to which the optional contact bridge is connected. In this regard, the electric actuator is expediently connected to the contact bridge, so that it can be moved by means of the electric actuator. The electric actuator is thus connected to the contact bridge via the contact bridge carrier. For example, the contact bridge is rigidly held on the contact bridge carrier. Alternatively, the contact bridge is movably mounted on the contact bridge carrier, expediently along the optional additional adjustment path. It is thus also possible to move the contact bridge relative to the contact bridge carrier, at least to a certain extent. In this way, it is possible in particular to compensate for any erosion of the movable and/or fixed contact.

Expediently, the contact bridge can protrude perpendicular to the additional adjustment path on both sides over the contact bridge carrier, with the formation of a respective protrusion. In this regard, one of the protrusions has the movable contact and the other protrusion has the optional additional movable contact. The contact bridge carrier is therefore arranged between the movable contacts. Preferably, the contact bridge carrier is located centrally between the two movable contacts, so that tilting or canting of the contact bridge is avoided when the contact bridge carrier is moved.

For example, the electric actuator can be attached directly to the optional contact bridge carrier. Thus, the number of required components is reduced. However, the electric actuator is particularly preferably attached to a slider. The slider and the contact bridge carrier are in turn expediently plugged into each other. In other words, the slider and the contact bridge carrier are different components, but they are plugged into each other. As a result, it is possible to move the contact bridge carrier using the slider. For example, the contact bridge carrier is inserted into the slider or, expediently, the slider is inserted into the contact bridge carrier. Preferably, the contact bridge carrier has a suitable receptacle for this purpose. Because of the slider, it is possible to make it and the contact bridge carrier from different materials, which is why a flexible adaptation of the switching unit is made possible. Thus, in particular, it is possible to make the contact bridge carrier from an electrically insulating material, such as a plastic, whereas the slider, for example, is made of metal. Nevertheless, a short circuit with the contact bridge is avoided due to the contact bridge carrier. Further, it is possible to manufacture the electric actuator, to which the slider is attached, and the mechanical switch with the contact bridge, which is connected to the contact bridge carrier, separately from each other. This makes manufacturing easier. It is also possible, for example, to create different electric actuators and different mechanical switches, which are then coupled together by means of the slider and the contact bridge carrier. It is possible to use one of the electric actuators with different mechanical switches and vice versa. Adaptation of the switching unit to the particular application is thus made possible, whereby a large number of different components do not have to be kept in stock. In other words, the switching unit is at least partially modular in design, which reduces manufacturing costs and increases flexibility.

The slider and the contact bridge carrier can be inserted into each other parallel to the additional adjustment path. When the switching unit is installed, these are then inserted into each other, for which the electric actuator is preferably moved parallel to the additional adjustment path towards the mechanical switch until the slider is inserted into the contact bridge carrier or vice versa. The space required for this is relatively small, so that this can also be done in the optional relatively cramped housing. Thus, manufacturing is simplified.

For example, the slider and the contact bridge carrier can be attached to one another. For example, the slider and the contact bridge carrier are glued or welded together. Alternatively, the contact bridge carrier and the slider are latched together, so that no additional materials or tools are required, which simplifies installation and can also be carried out in confined spaces. Particularly preferably, the slider and the contact bridge carrier each have an opening that is congruent with one another when they are inserted into one another. The opening runs suitably perpendicular to the optional additional adjustment path. It is thus possible to attach the slider and the contact bridge carrier to each other by inserting an object, such as a wire or a rod, if this is desired.

Preferably, the armature can be located on the side of the first stop when the mechanical switch is in the closed state, and the armature is located on the side of the second stop when the mechanical switch is in the open state. In this case, for example, the first holding force is greater than the second holding force. Particularly preferably, however, the first holding force is less than the second holding force. If there is a fault, it is only necessary to overcome the relatively low initial holding force in order to open the mechanical switch. It is also ensured in this way that the switching speed for opening the mechanical switch is accelerated, especially if the electric actuator is always energized in the same way, that is, in particular with the same electric current strength. In the event of a fault or the like, it is ensured that the current flow is safely and quickly interrupted by the switching unit. It is also ensured due to the increased second holding force that as soon as the mechanical switch is in the open state, switching back on, that is, a transfer to the closed state, only occurs if this is also desired and a relatively large force is exerted on the armature. In other words, an unintentional movement of the switching unit into the electrically conductive state is prevented, for example, in the event of a shock to the switching unit. For example, the first holding force is selected in such a way that, for example, in the event of a shock or an unintentional change in position of the switching unit due to the changed weight force, the first holding force is overcome, so that the mechanical switch is spaced apart from the first stop. Due to the reduced distance to the second stop and the force acting there, the mechanical switch is then transferred to the open state. Safety is thus increased, even if, for example, the availability of the switching unit is reduced.

Expediently, the second holding force can be greater than or equal to twice, five times, ten times, or twenty times the first holding force. Thus, there is a significant difference in the switching speed of the mechanical switch depending on the direction in which the armature is moved along the adjustment path. The first holding force is particularly preferably between 0.1 N and 5 N and is, for example, between 0.5 N and 1 N or between 1.5 N and 2 N. It is ensured in this way that there is no movement away from the first stop due to minor shocks to the switching unit, whereby, however, no excessive force is required to move the armature from the first stop in the direction of the second stop. In addition, due to such a low first holding force, if the mechanical switch is to be opened, remagnetization of the electric actuator is essentially not required, or this takes place relatively quickly, so that the switching speed is further accelerated.

Alternatively or in combination with this, the second holding force can be greater than or equal to 10 N or 15 N. In this case, the second holding force is particularly preferably greater than 20 N or 30 N. Suitably, the second holding force is less than 100 N. Due to this type of design, it is thus ensured that the force acting between the second stop and the armature already leads to a significant acceleration of the armature when it is still spaced apart from the second stop; this increases the switching speed further. It is also ensured that the mechanical switch remains in the open state as soon as the armature has been moved to the second stop. Thus, restarting the switching unit, that is, conducting of a current, is only possible by applying a relatively large force to the armature, which essentially cannot happen unintentionally.

For example, the armature may not be in contact with the second stop when the mechanical switch is in the open state. Thus, this end of the adjustment path is spaced apart from the second stop. Particularly preferably, however, the armature is in contact with the second stop when the mechanical switch is in the open state. Thus, in order to provide the increased second holding force, it is not necessary to use relatively large and/or cost-intensive components.

For example, the armature is contact with the first stop when the mechanical switch is in the closed state. Particularly preferably, however, in the closed state of the mechanical switch, the armature is spaced apart from the first stop. In this case, in particular, this prevents the contact of the armature with the first stop, because the movable contact is contact with the optional fixed contact. When the armature is moved towards the first stop, the movable contact is also moved towards the fixed contact due to the mechanical coupling/connection of the armature to the movable contact. In this case, however, the movement of the armature is stopped before the first stop if further movement of the movable contact is prevented due to the mechanical contact with the fixed contact. In other words, due to the contact between the movable contact and the fixed contact, it is not possible to move the armature any further, even if the first holding force acts between them.

For example, a relative movement of the movable contact relative to the armature is possible to a small extent, or particularly preferably these are rigidly coupled to each other, so that a relative movement of the movable contact to the armature is prevented. Due to such a design, on the one hand, a force acts essentially continuously on the movable contact in the closed state in the direction of the fixed contact. In other words, a continuous contact pressure is realized, which is why the electrical resistance of the mechanical switch is reduced in the closed state. On the other hand, the position of the movable contact in the closed state is not determined by the first stop. If the movable contact/fixed contact has a smaller and/or reduced extent, the movable contact can be moved further until it comes into contact with the fixed contact. In this respect, the armature is also moved further in the direction of the first stop, so that the end of the adjustment path is shifted. Consequently, it is always possible to bring the movable contact to be in contact with the fixed contact, regardless of whether there are any manufacturing tolerances or deformation of the movable contact/fixed contact. Consequently, any arising erosion of the movable contact and/or the fixed contact can be compensated for in this way, that is, in particular material removal and/or a reduction in size. This type of erosion occurs in particular if an arc forms between the movable contact and the fixed contact when the mechanical switch is opened. It is therefore possible to use the switching unit for a relatively long period of time and/or to carry out many switching operations. Any manufacturing tolerances, for example, of the individual components and/or during assembly of the switching unit are compensated for in this way, which is why manufacturing costs are reduced. If the armature is moved in the direction of the second stop when the electric actuator is energized, that is, when the mechanical switch is to be opened, the movement of the armature is immediately transferred to the movable contact due to the rigid coupling of the armature to the movable contact, which is then spaced apart from the fixed contact, so that a switching speed is further accelerated. In this regard, however, it is possible to compensate for any erosion and/or manufacturing tolerances. In a refinement, the force acting on the armature is essentially 0 N when the movable contact is in contact with the fixed contact.

The contact bridge, which has the movable contact, is particularly preferred. In this case, for example, the contact bridge is only driven by the electric actuator. In other words, a force is only exerted on the contact bridge by means of the electric actuator. Particularly preferably, however, the switching unit comprises a return spring. By means of this, the contact bridge is preferably subjected to a spring force, that is, spring-loaded. The spring force acts in addition to the first/second holding force provided due to the magnetic fields. The return spring is expediently arranged and/or designed in such a way that the spring force is applied to the contact bridge. In this case, the force applied expediently leads to the mechanical switch closing, that is, to the movable contact moving against the fixed contact. For example, the return spring lies mechanically against the contact bridge either directly or via other components. The switching unit is expediently designed in such a way that the mechanical switch is closed by means of the return spring, in particular when the electric actuator is not in operation and/or the contact bridge is not blocked; that is, movement of the contact bridge is possible in principle. Particularly preferably, however, this occurs only if the armature has a certain distance to the second stop. Thus, the mechanical switch is held in the open state as long as the second holding force is not overcome by means of an additional force, which can in particular only be provided by energizing the electric actuator. Due to the return spring, the force required to initially distance the movable contact from the fixed contact is initially relatively low and increases as the distance between the movable contact and the fixed contact increases. Thus, a relatively rapid movement of the contact bridge occurs at the start of operation of the electric actuator, which is why the switching speed is increased.

For example, the armature can be formed by means of a permanent magnet. The manufacturing costs and the weight of the armature are thus reduced, which increases the dynamics of the electric actuator. However, the armature particularly preferably has a first cover and a second cover, between which the permanent magnet is arranged. The first cover is located on the side of the first stop and the second cover on the side of the second stop. The permanent magnet in particular is therefore arranged between the covers in a direction parallel to the adjustment path. The covers are preferably attached to the permanent magnet.

Expediently, the armature can be formed by means of the two stops and the permanent magnet, which is why manufacturing costs are reduced. For example, the two covers are attached to each other or at least touch each other. Alternatively, the two covers are spaced apart from each other. The covers are preferably in contact with the permanent magnet. Due to the covers, a mechanical impact on the respective stop is at least partially intercepted, so that the forces then acting are not or only slightly introduced into the permanent magnet. Thus, damage to the permanent magnet is prevented or at least a mechanical load on the permanent magnet is reduced, which is usually relatively brittle.

In this case, preferably, the covers can have certain magnetic properties, and these are, for example, at least partially ferromagnetic, para- and/or diamagnetic. In particular, it is realized due to the different covers that the first and second holding forces are different, which can be realized relatively cost-effectively. The two covers here are expediently differentiated by their magnetic properties. For example, the two covers are structurally identical to one another. It is thus possible to use common parts. In particular, both have at least one corresponding option for connecting the mechanical switch. Alternatively, this only exists for one of the two. Thus, there is a clear assignment of each cover to the first or second stop, which makes manufacturing easier.

For example, the two covers can have the same shape. Thus, the formation of an imbalance in particular is prevented. Preferably, however, the two covers are shaped differently. In this way, it is possible to adjust the two holding forces relatively precisely. Here, the two covers differ, for example, due to their lateral extent perpendicular to the adjustment path or, expediently, due to their extent along the adjustment path. For example, one of the covers, preferably the second cover, is made entirely of a ferromagnetic material. For example, this cover is a single piece. The other cover is made of a dia- or paramagnetic material, for example, and is composed of different components, which makes it easier to form the holding force. In addition, ferromagnetic components are also preferable.

Particularly preferably, both covers comprise multiple ferromagnetic disks which are structurally identical to each other. For example, the two covers are formed here by means of the corresponding disks or comprise additional components. In particular, the ferromagnetic disks are made of iron or steel. The ferromagnetic disks are expediently arranged perpendicular to the adjustment path. In this regard, the number of ferromagnetic disks associated with the different covers varies. Preferably, the number of ferromagnetic disks associated with the second stop is increased. Thus, the formation of any increased second holding force is made easier. It is also possible in this way to design the electric actuator to be essentially symmetrical and to use common parts. To provide the different holding forces, it is therefore only necessary to assign fewer ferromagnetic disks to one of the covers. It is also ensured in this way that the armature is spaced apart from the first stop when the movable contact is in contact with the fixed contact.

For example, one or both stops can have a permanent magnet. Particularly preferably, however, the stops each have a ferromagnetic base body, which is formed in particular by means of a sheet made of iron or steel, for example. Thus, manufacturing costs are reduced. A dia- and/or paramagnetic element is expediently arranged on one of the base bodies on the armature side. In particular, however, the element forms part of the electric actuator. The element is expediently in contact with the associated base body. For example, there are multiple elements of this type, which are expediently in direct mechanical contact with each other.

For example, the element covers the associated base body completely or only partially. In particular, the element is realized by means of a plastic disk. Mechanical damping is thus realized at least partially, and manufacturing costs are reduced. For example, the element is designed to be self-supporting. Alternatively, the element is formed, for example, by means of a coating, in particular a galvanic coating. The para-/diamagnetic element is suitably associated with the first stop. Preferably, no such element is associated with the second stop, or the second stop comprises a ferromagnetic element. The two elements are suitably shaped in the same way and differ in particular only in that one of them is ferromagnetic and the other is para-/diamagnetic. Thus, the two stops have the same extent but different magnetic properties. In this way, it is realized in particular that the two holding forces are different from each other.

The invention further relates to a circuit breaker with such a switching unit. The circuit breaker is used in particular to interrupt an electric current in the event of a fault, for example, an overcurrent and/or a short-circuit current. Alternatively or in combination with this, the flow of electric current is interrupted by means of the circuit breaker if an applied electric voltage is excessive or if it is detected that an arc is present. For this purpose, the circuit breaker expediently has a sensor by means of which any faults in particular can be detected. The sensor is suitably used to detect the status of the circuit breaker and/or the electric current carried by the circuit breaker. Expediently, multiple corresponding sensors are present, so that a relatively accurate determination of different fault cases is possible. For example, one of the sensors is designed as a voltage sensor and another as a current sensor.

The circuit breaker can comprise a control unit that is connected to the sensor in terms of signaling. The switching unit is actuated by means of the control unit, preferably depending on the measurement data captured by the sensor and/or when the fault has been detected. For this purpose, the measurement data provided by the sensors is expediently evaluated by the control unit. If a fault occurs, the mechanical switch is opened, in particular by means of the control unit, and thus set to the nonconductive state. For this purpose, the actuator in particular is energized accordingly.

The refinements and advantages explained in connection with the switching unit are analogously also to be applied to the circuit breaker and each other and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a direct-current circuit with a load and a circuit breaker which comprises a switching unit;

FIGS. 2 and 3 show in perspective or in a sectional view show the circuit breaker with the switching unit, which comprises an electric actuator and a mechanical switch with a contact bridge held on a contact bridge carrier;

FIGS. 4 and 5 shows in a sectional view or in perspective show the contact bridge held on the contact bridge carrier;

FIGS. 6 and 7 schematically show in a sectional view the electric actuator when the mechanical switch is in an open or closed state; and

FIG. 8 shows in a sectional view an alternative embodiment of the electric actuator.

### DETAILED DESCRIPTION

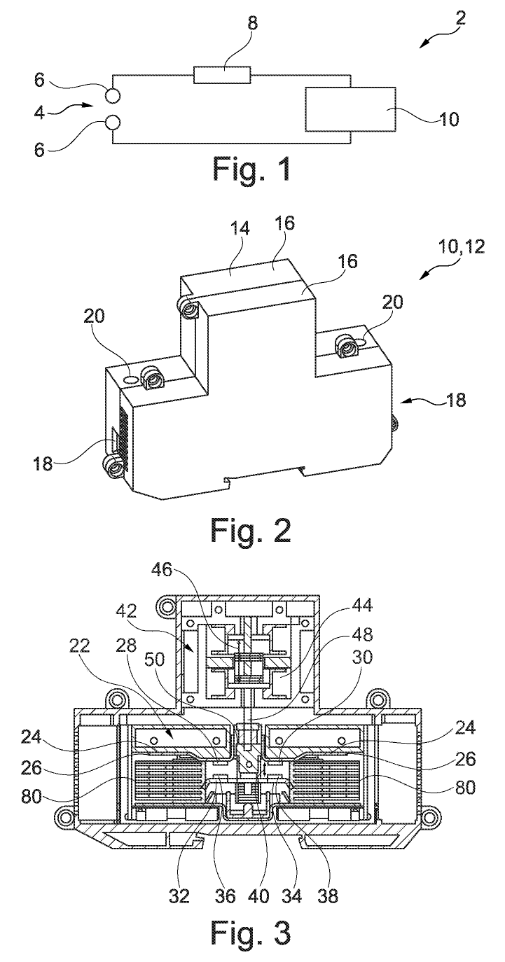

A DC voltage circuit 2 comprising a DC voltage source 4 is shown schematically simplified in FIG. 1. This is used to provide an electric DC voltage of 650 V, which is applied between poles 6 of DC voltage source 4. Load 8 is directly connected to one of the poles 6 and electrically connected to the other via a circuit breaker 10. A circuit is thus formed.

Circuit breaker 10, which comprises a switching unit 12, is shown in perspective in FIG. 2. Switching unit 12 has a housing 14 with two housing halves 16, which are joined together and are made of a plastic. Two openings are made in housing 14, within each of which a device terminal 18 is arranged. An electric line leading to DC voltage source 4 or load 8 can be connected there. Device terminals 18 each have clamping screws, not shown in further detail, which are accessible through a mounting opening 20 of housing 14. By screwing in the clamping screws, the line associated with the respective device terminal 18 is clamped and thus electrically contacted.

FIG. 3 shows switching unit 12 in a sectional view. This has a mechanical switch 22 which is arranged inside housing 14 and comprises two terminals 24 which are spaced apart from one another. Terminals 24 each comprise a terminal body 26, which is designed as a busbar and is made of tinned copper. The two terminal bodies 26 are arranged essentially in a common plane, and each terminal body 26 is electrically connected in each case to one of device terminals 18 by means of a line. A fixed contact 28 is welded to one of the terminal bodies 26 and another fixed contact 30 is welded to the other; these are made of a relatively arc-erosion-resistant and electrically conductive material.

Further, mechanical switch 22 has a contact bridge 32 comprising a substantially strip-shaped bridge body 34, which is also made of tinned copper. A movable contact 36 and an additional movable contact 38 are welded to bridge body 34 and are made of the same material as the two fixed contacts 28, 30. Contact bridge 32 is mounted so as to be movable along an additional adjustment path 40, which is essentially perpendicular to the extent of bridge body 34. It is thus possible to move bridge body 34 along additional adjustment path 40. When moving in one direction along additional adjustment path 40, movable contacts 36, 38 are spaced apart from fixed contacts 28, 30, and mechanical switch 22 is transferred to the open state, and the two device terminals 18 are galvanically isolated from each other. In the case of an opposite movement, in contrast, it is possible to mechanically bring movable contact 36 into contact with fixed contact 28 and additional movable contact 38 into contact with additional fixed contact 30. Mechanical switch 22 is then in the closed state, and any further movement of contact bridge 32 in this direction is then prevented due to the contact. When the mechanical contact is established, the two device terminals 28 are electrically conductively connected by means of mechanical switch 22, which is then closed.

Switching unit 12 additionally has an electric actuator 42, which is also arranged in housing 14. Electric actuator 42, which is also referred to simply as actuator 42, is operated by means of a control unit of circuit breaker 10, a control unit and is also arranged in housing 14. In this case, the control unit is connected in terms of signals to a sensor, by means of which the electric current conducted by switching unit 12 can be characterized and/or detected. Electric actuator 42 is operated depending on the measurement data captured by the sensor.

Electric actuator 42 has an armature 44, which is mounted so as to be movable along an adjustment path 46, which is parallel to additional adjustment path 40. Armature 44 is attached to an actuating rod 48 which is arranged parallel to adjustment path 46 and in turn is rigidly connected at the end to a slider 50. Slider 50 and actuating rod 48 are made of metal, so that they are relatively robust.

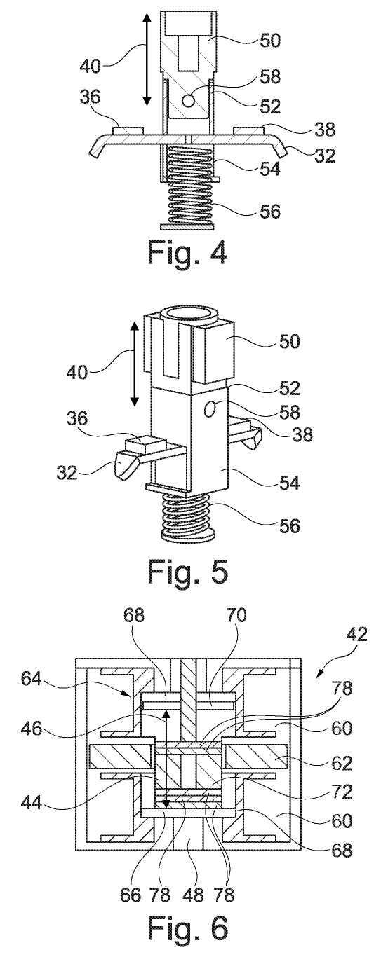

Slider 50, which is also shown enlarged in the sectional view along additional adjustment path 40 in FIG. 4 and in perspective in FIG. 5, is inserted in a receptacle 52 of an essentially cuboid contact bridge carrier 54, which is made of plastic. The cuboid shape extends along additional adjustment path 40, and the two end faces are open, so that contact bridge carrier 54 is hollow-cylindrical with a rectangular cross section. In this case, receptacle 52, into which slider 50 is inserted, is provided by means of one of the end faces. A return spring 56, which is supported on contact bridge 32 and indirectly via a holder on housing 14, protrudes through the opposite end face. Contact bridge 32 is thus spring-loaded by means of a return spring 56.

Contact bridge 32 is rigidly attached to contact bridge carrier 54. In this regard, contact bridge 32 is guided through contact bridge carrier 54 perpendicular to additional adjustment path 40, so that a projection is formed perpendicular to additional adjustment path 40. One of the projections has movable contact 36 and the other has the additional movable contact 38. Slider 50, namely, the part inserted into contact bridge carrier 54, and contact bridge carrier 54 each have an opening 58, arranged congruently with one another, as shown in FIGS. 4 and 5. For rigid coupling, a rod is passed through the two openings 58, like a wire. Thus, contact bridge carrier 54 is also always moved by slider 50. Slider 50 and contact bridge carrier 54 are thus rigidly coupled to each other. Therefore, contact bridge carrier 54 and therefore also contact bridge 32 are always moved when actuating rod 48 and therefore also armature 44 are moved. These are also always moved synchronously.

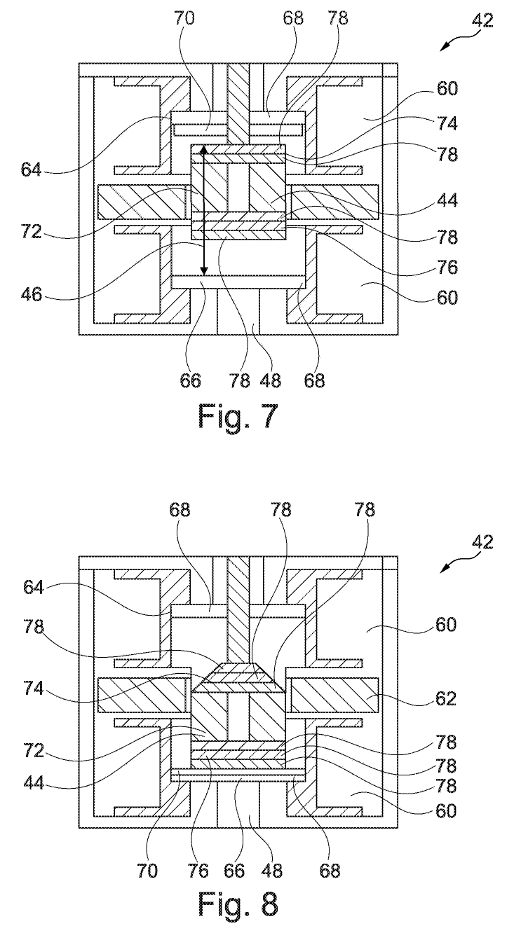

Electric actuator 42 is shown in a sectional view along adjustment path 46 in FIG. 6 when mechanical switch 22 is open, and in FIG. 7 when mechanical switch 22 is closed. Electric actuator 42 is designed as a "moving magnet actuator" and has two electrical coils 60, which are structurally identical and arranged concentrically to one another. These are offset from one another along adjustment path 46, and a ring-shaped short-circuit plate 62 made of a ferromagnetic material, namely, iron, is arranged between them.

Along the axis of electrical coils 60, armature 44 is mounted so as to be movable between a first stop 64 and a second stop 66, one of which is assigned to each of the electrical coils 60. Stops 64, 66 are arranged perpendicular to the axes of electrical coils 60 and are offset from the opposite end faces of each electrical coil 60 into the interior of the respective electrical coil 60. Each stop 64, 66 has a ferromagnetic base body 68, which is made of iron and is arranged perpendicular to the adjustment path 46 and concentric to the axes of electrical coils 60. A magnetic element 70 is arranged on base body 68 of first stop 64, parallel to it and covering it at the end face, and is located on the end face facing armature 44. Element 70 is provided by means of a plastic disk which is attached to the base body 68, so that a kind of sandwich structure is formed. Second stop 66, in contrast, is only formed by means of base body 68.

Armature 44 has a hollow cylindrical permanent magnet 72 arranged concentrically to the axis of electrical coils 60 and attached to actuating rod 48. Permanent magnet 72 is magnetized parallel to adjustment path 46, and the end face facing first stop 64 is covered over its entire surface by means of a first cover 74 and the side face facing the second stop 66 is covered by means of a second cover 76; these are attached to the permanent magnets 72. The two covers 74, 76 are each formed by means of a plurality of structurally identical ferromagnetic disks 78, which are arranged perpendicular to adjustment path 46 and stacked on top of one another. Here, first cover 74 is formed by two such ferromagnetic disks 78 and second cover 76 by three such ferromagnetic disks 78. The two covers 74, 76 are therefore shaped differently.

When mechanical switch 22 is open, second cover 76 is in contact with its entire surface with second stop 66. Thus, the movement of armature 44 and therefore also the movement of contact bridge 32 along additional adjustment path 40 is restricted by means of second stop 66. When electrical coils 60 are not energized, a second holding force is formed between armature 44 and second stop 66 due to permanent magnet 72, ferromagnetic disks 78, and base body 68. By means of these, armature 44 is thus held at one end of adjustment path 46, namely, at second stop 66. Second holding force is greater than 20 N and is 30 N, for example, depending on the rated current of circuit breaker 10.

In the closed state of mechanical switch 22, the movement of contact bridge 32 is limited due to the contact between movable contacts 36, 38 and the respective fixed contact 28, 30. In this case, armature 44 is spaced apart from first stop 64. In other words, in the closed state of mechanical switch 22, armature 44 is spaced apart from first stop 64 due to the rigid coupling of armature 44 to movable contacts 36, 38 and their contact with the respective fixed contact 28, 30. Adjustment path 46 thus does not extend as far as first stop 64. A first holding force acts between armature 44 and first stop 64 due to permanent magnet 72, ferromagnetic disks 78, and base body 68. However, it is reduced in comparison to the second holding force due to paramagnetic element 70, on the one hand, and due to the reduced number of ferromagnetic disks 78 and the distance between armature 44 and first stop 64, on the other. The first holding force is between 0.1 N and 5 N, namely, 1.5 N.

In summary, the magnetic first holding force is thus formed between first stop 64 and armature 44 and the magnetic second holding force is formed between second stop 66 and armature 44, the first holding force being less than the second holding force. When mechanical switch 22 is in the closed state, armature 44 is on the side of first stop 64, but spaced apart from it, and the first holding force is formed. When mechanical switch 22 is in the open state, armature 44 is on the side of second stop 66 and is in contact with it, whereby the second holding force is formed.

In order to transfer mechanical switch 22 to the closed state, it is therefore necessary to bridge the second holding force minus the force provided by return spring 56. For this purpose, it is necessary to energize electrical coils 60. As soon as armature 44 is detached from second stop 66, the force acting between armature 44 and second stop 66 decreases relatively sharply with increasing distance. Therefore, even when the current to electrical coils 60 is subsequently ended, contact bridge 32 is moved further along additional adjustment path 40 and therefore armature 44 as well along adjustment path 46 in the direction of first stop 64 due to the relaxation of return spring 56, namely, until movable contacts 36, 38 are in contact with the respective fixed contact 28, 30 and the first holding force acts. Mechanical switch 22 is then held in the closed state by means of this and return spring 56, no energization of electrical coils 60 being required for this.

When mechanical switch 22 is to be opened, electrical coils 60 are energized in the opposite direction. Due to the low acting magnetic first holding force, only a slight remagnetization of electric actuator 42 is required, which is why armature 44 moves essentially immediately after the start of energization and movable contacts 36, 38 are spaced apart from fixed contacts 28, 30, which is why a switching speed is increased.

If an arc were to form between movable contacts 36, 38 and the respective associated fixed contact 28, 30 when mechanical switch 22 is opened, these are assigned extinguishing chambers 80, which have a number of splitter plates stacked on top of one another. Extinguishing chambers 80 also comprise blowing devices for moving the respective arc between the splitter plates.

However, once the arc occurs, movable contacts 36, 38 and fixed contacts 28, 30 are subjected to thermal loading and are partially melted/deformed. It is possible that their size will be reduced. In the closed state of mechanical switch 22, the movement of contact bridge 32 along additional adjustment path 40 is only limited due to the contact of movable contacts 36, 38 with fixed contacts 28, 30. If movable contacts 36, 38/fixed contacts 28, 30 are deformed, the movement of contact bridge 32 is only stopped later, and armature 44 can be moved towards first stop 64. In other words, the erosion is compensated for. In summary, as movable contacts 36, 38 and fixed contacts 28, 30 undergo progressive erosion, in the closed state of mechanical switch 2, armature 44 is brought progressively closer to first stop 64.

An alternative of electric actuator 42 is shown in FIG. 8, wherein short-circuit plate 62 and electrical coils 60 are not changed. Base bodies 68 associated with first stop 64 and second stop 66 are also unchanged. However, element 70 is not assigned to first stop 64 but is associated with second stop 66. Element 70 is made of a ferromagnetic material or is, for example, a permanent magnet. Second cover 76 with the three ferromagnetic disks 78 has not been changed. First cover 74 continues to have ferromagnetic disks 78, but these are now no longer structurally identical and there are now three of them. The diameter of ferromagnetic disks 78 decreases with increasing distance from permanent magnet 72, which is why first cover 74 is essentially conical. In this embodiment of electric actuator 42 as well, the first holding force is also less than the second holding force, which is greater than 40 N, for example, 80 N. The first holding force, to the contrary, is 2.5 N, wherein here as well armature 44 is spaced apart from first stop 64 in the closed state of mechanical switch 22.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A switching unit comprising:
a mechanical switch that is driven via an electric actuator that has an armature mounted so as to be movable along an adjustment path between a first stop and a second stop, the electric actuator being designed such that a magnetic first holding force is formed between the first stop and the armature and a magnetic second holding force is formed between the second stop and the armature, the first holding force differing from the second holding force.

2. The switching unit according to claim 1, wherein the armature is located on the side of the first stop when the mechanical switch is in a closed state, wherein the armature is located on the side of the second stop when the mechanical switch is in an open state, and wherein the first holding force is less than the second holding force.

3. The switching unit according to claim 2, wherein the first holding force is between 0.1 N and 5 N and/or wherein the second holding force is greater than 10 N or 30 N.

4. The switching unit according to claim 2, wherein the armature is rigidly coupled to a movable contact of the mechanical switch, wherein in the closed state the armature is spaced apart from the first stop due to contact of the movable contact with a fixed contact of the mechanical switch.

5. The switching unit according to claim 2, wherein a contact bridge having the movable contact is spring-loaded via a return spring.

6. The switching unit according to claim 1, wherein the armature comprises a first cover on the side of the first stop and a second cover on the side of the second stop between which a permanent magnet is arranged.

7. The switching unit according to claim 6, wherein the first and second covers are shaped differently.

8. The switching unit according to claim 7, wherein the first and second covers comprise at least two ferromagnetic disks arranged substantially perpendicular to the adjustment path and structurally identical to one another, and wherein the two numbers differ.

9. The switching unit according to claim 1, wherein each stop has a ferromagnetic base body, wherein a para- or diamagnetic element is arranged on one of the base bodies on a side of the armature.
